(19) United States
(12) Patent Application Publication
(10) Pub. No.: US 2014/0261004 A1
(43) Pub. Date: Sep. 18, 2014

(54) COFFEE BREWING POT

(71) Applicant: Oganes Kalpakchyan, Los Angeles, CA (US)

(72) Inventor: Oganes Kalpakchyan, Los Angeles, CA (US)

(21) Appl. No.: 13/802,797

(22) Filed: Mar. 14, 2013

(51) Int. Cl. A47J 31/46

(52) U.S. Cl. CPC A47J 31/46
USPC 99/323

(57) ABSTRACT

A coffee brewing pot designed to brew coffee without a filter. More specifically, designed for use to brew coffee that is grounded to an extra-fine powder and brewed without the use of a filter, as is commonly done in countries like Greece, Turkey, and Armenia. The present invention has a coffee holder into which the grounded coffee and other ingredients are placed and an overflow trap designed to catch any coffee foam and/or coffee that overflows due to the heat as it is brewed. Additionally, a heat trap is attached around the bottom section of the coffee holder so as to trap heat that is then dissipated to the coffee through the sidewall of the coffee holder. Thus, with heat dissipated from the bottom and the sidewalls for a faster and more consistent brew.

### FIELD OF INVENTION

The present invention relates to a coffee brewing pot. More specifically, the present invention relates to a coffee brewing pot that brews coffee without a filter.

### DESCRIPTION OF PRIOR ART

The process of brewing coffee in the United States and most of the Western World involves filtering grounded coffee. However, in other parts of the world, including Turkey, Greece, and Armenia, coffee is grounded to an extra-fine powder and brewed without the use of a filter. The lack of a filter ultimately results in coffee that is stronger and more flavorful than coffee brewed with a filter.

Brewing coffee without a filter in countries such as Turkey, Greece, and Armenia, is done by the use of a pot called an “ibrik” or a “cezve”. To brew coffee with an ibrik, extremely finely ground coffee is first poured therein. Then water, sugar, and/or other spices are added. Finally, the ibrik is placed within a heat source for brewing. Traditionally, the brewing process involved placing the ibrik within hot sand. However, today the ibrik is placed over the fire from a typical gas stove.

As the ibrik is heated, coffee foam is created and begins to rise therewithin at an increasing rate. The user brewing the coffee must pay extra careful attention as the ibrik is heated. As the coffee foam rises up to the top rim of the ibrik, the user must immediately remove the ibrik from the heat source. Failure to do so results in the coffee foam and coffee overflowing out of the ibrik causing a very messy situation all over the stove and losing a substantial amount of the coffee. If the ibrik is removed from the heat source in time, the foam and coffee settle back down and the messy situation is avoided. After the foam and coffee settle back down, the ibrik is replaced within the heat source to repeat the process. This process is typically repeated three to four times until the coffee is brewed and ready for consumption.

As such, the use of an ibrik to brew coffee requires some skill, practice, and very careful attention at the raising coffee foam. Looking away for a split second can result in a very messy situation where the user is cleaning the stove rather than enjoying a cup of coffee.

Thus, a heretofore unaddressed need exists for a pot that can be used to brew extremely finely ground coffee without a filter and with a feature or mechanism that prevents the messy situation from occurring and retains all of the coffee for enjoyment and consumption.

### SUMMARY OF THE INVENTION

Accordingly, the present invention has been made in view of the above-mentioned disadvantages occurring in the prior art. The present invention is a coffee brewing pot that can be used to brew coffee without a filter as is done by an ibrik. A coffee holder into which the coffee and other ingredients are placed, is surrounded by an overflow trap that serves to catch any overflow of coffee and coffee foam so as to prevent a messy situation.

It is therefore a primary objective of the present invention to provide a coffee brewing pot that brews coffee without a filter and prevents any overflow of coffee and coffee foam from pouring on to the stove or heat source.

Another object of the present invention is to provide a coffee brewing pot that continues to brew any coffee that overflow from the coffee holder and allows the coffee to be poured with ease into a cup for consumption.

Yet another object of the present invention is to provide a coffee brewing pot that retains heat from the heat source within a heat trap so that the coffee within the coffee holder can be heated from the bottom and the sidewalls to mimic the traditional method of brewing coffee in hot sands.

Yet another object of the present invention is to provide a coffee brewing pot with pouring lips and an insulated handle to facilitate the pouring of the brewed coffee into a cup from which it is ultimately consumed.

The above objects and other features of the present invention, as well as the structure and operation of various embodiments of the present invention, are described in detail below and with reference to the accompanying drawings.

### DESCRIPTION OF THE DRAWINGS

The accompanying drawings which are incorporated by reference herein and form part of the specification, illustrate various embodiments of the present invention and, together with the description, further serve to explain the principles of the invention and to enable a person skilled in the pertinent art to make and use the invention. In the drawings, like reference numbers indicate identical or functional similar elements. A more complete appreciation of the invention and many of the attendant advantages thereof will be readily obtained as the same becomes better understood by reference to the following detailed description when considered in connection with the accompanying drawings, wherein:

FIGS. 1A and 1B are perspective views of the coffee brewing pot of the present invention in its assembled state as it would be used to brew coffee.

FIG. 2 is an exploded view of the coffee brewing pot of the present invention.

FIGS. 3A and 3B are perspective views of the coffee holder of the present invention.

FIGS. 4A and 4B are perspective views of the overflow trap of the present invention.

FIGS. 5A and 5B are perspective views of the heat trap of the present invention.

FIG. 6 is a perspective view of the handle of the present invention.

### DETAILED DESCRIPTION OF THE INVENTION

Reference will now be made to the drawings in which various elements of the present invention will be given numerical designations and in which the invention will be discussed so as to enable one skilled in the art to make and use the present invention.

The coffee brewing pot 100 of the present invention comprises a coffee holder 10, a handle 20, an overflow trap 30, and a heat trap 40. FIGS. 1A and 1B shows a perspective view of the coffee brewing pot 100 of the present invention in its assembled state as it would be used to brew coffee. FIG. 2 shows an exploded view of the coffee brewing pot 100 of the present invention to depict in greater detail the various components that comprise the coffee brewing pot 100. The main component of the present invention is the coffee holder 10 into which coffee, water, sugar, and/or other spices are placed for brewing.

As shown in FIGS. 3A and 3B, the coffee holder 10 has a bottom plate 11 from which an annular sidewall 12 extends upwardly to define an upwardly open cavity 13. The top end of said annular sidewall 12 is concave to define a narrowing neck 14 that is terminated by the top rim 15. A section at the top end of said annular sidewall 12 is convexly shaped into a first pouring lip 16.

FIGS. 4A and 4B shows a perspective view of the overflow trap 30 that is attached to the annular sidewall 12. The overflow trap 30 has a base 31 from which an annular outside wall 32 and an annular inside wall 33 extend upwardly to define an annular cavity 34. It is preferred that the annular outside wall 32 extend higher than the annular inside wall 33. A section at the top end 35 of said annular outside wall 32 is convexly shaped into a second pouring lip 36 similar in shape and configuration as the first pouring lip 16.

FIGS. 5A and 5B shows a perspective view of the heat trap 40 that is attached underneath the overflow trap 30. The heat trap 40 of the preferred embodiment of the present invention is primarily a single annular wall 41 having a top end 42 and a bottom end 43.

FIG. 6 shows a perspective view of the handle 20 that is attached to the annular outside wall 32 of the overflow trap 30. The handle 20 has a stem 21 that is partially covered by an insulating cover 22. A first end 23 of the handle 20 has an attachment plate 25 that is attached to the annular outside wall 32 of the overflow trap 30 such that said handle is angled with its second end 24 located above its first end 23, as shown in FIGS. 1A and 1B. In essence, the handle 20 is attached to the overflow trap 30 in an upwardly angled configuration.

Hereinafter, an explanation on the methods of assembling the product of the present invention and the operating states thereof will be given.

For the assembly of the coffee brewing pot 100 of the present invention, the overflow trap 30 is attached to the coffee holder 10 such that the top end 35 of its annular side wall 32 is positioned at or around the same height as the top rim 15 and the first pouring ring 16 is aligned with the second pouring ring 36, as shown in FIGS. 1A and 1B. The attachment of the overflow trap 30 can be accomplished by joining the annular inside wall 33 of the overflow trap 30 to the annular sidewall 12 of the coffee holder 10. The joining of the overflow trap 30 to the coffee holder 10 can be with weld joints, adhesives, screws or nuts, mechanical joints, or a variety of other methods. However, the preferred method is weld joints.

Then the top end 42 of the heat trap 40 is attached to the base 31 of the overflow trap 30, as shown in FIGS. 1A and 1B. The height of the heat trap 40 is such that its bottom end 43 is at or around the same level as the bottom plate 11 of the coffee holder 10. As before, the joining of the heat trap 40 to the overflow trap 30 can be with weld joints, adhesives, screws or nuts, mechanical joints, or a variety of other methods. However, the preferred method is weld joints.

Finally, the handle 20 is attached to the annular outside wall 32 of the overflow trap 30 such that it is angled with its second end 24 located above its first end 23, as shown in FIGS. 1A and 1B. As before, the attachment of the handle 20 can be accomplished with weld joints, adhesives, screws or nuts, mechanical joints, or a variety of other methods. However, the preferred method is weld joints.

The assembly of the coffee brewing pot 100 of the present invention as discussed above is expected to be completed by the manufacturer prior to the distribution or sale to a consumer.

To use the coffee brewing pot 100 of the present invention, the user first adds the ingredients, including water, finely grounded coffee, sugar, and/or other spices, into the open cavity 13 of the coffee holder 10. It is preferred that sufficient ingredients are added to fill the open cavity 13 up to the bottom of the narrowing neck 14. Subsequently, the coffee brewing pot 100 is placed within a heat source, preferably over a flame from a gas stove. As the coffee brewing pot 100 is heated, coffee foam is created within the open cavity 13 and begins to rise until coffee foam and coffee overflows over the top rim 15. However, rather than creating a messy situation all over the stove, the coffee and coffee foam overflow into the annular cavity 34 of the overflow trap 30.

After the overflow, the coffee in the coffee holder 10 settles down a bit until it generates coffee foam again. The foam rises again until a second overflow in which more coffee and coffee foam overflows into the overflow trap 30. The process repeats until the coffee reaches the preferred level of brew at which point the coffee brewing pot 100 is removed from the heat source.

Removal of the coffee brewing pot 100 from the heat source is accomplished by the use of the handle 20. Since the handle 20 is angled upwardly, the second end 24 is located further away from the heat source than the first end 23. Furthermore, the insulating cover 22 is closer to the second end 24 and insulates the handle 20 so that the user can hold on to it to pick up and/or move the coffee brewing pot 100 without any burning injuries.

When the coffee is properly brewed and ready for consumption, the coffee brewing pot 100 is picked up and tilted over so as to pour the coffee into a cup. As the coffee brewing pot 100 is tilted over a cup, the coffee in the coffee holder 10 is poured through the first pouring ring 16 while the coffee in the annular cavity 34 of the overflow trap 30 is poured through the second pouring ring 36. Thus, all of the coffee is ready for consumption and the brewing process occurs without creating any messy situations by overflowing coffee on to the gas stove. Most important, brewing coffee with the coffee brewing pot 100 of the present invention does not require a user that is skilled and well-practiced in the art of removing the pot from the flame just in time to avoid a messy overflow of coffee. In fact, the coffee brewing pot 100 of the present invention can be used by anyone since the pot 100 is left on the heat source until the coffee is properly brewed. Periodic removal of the pot 100 from the heat source is not required since any overflow of coffee is captured and retained by the overflow trap 30.

Traditionally, brewing coffee with an ibrik was done by placing the ibrik within hot sand so that heat would dissipate into the coffee through the bottom and through the sides. However, now that coffee in an ibrik is brewed over fire from a typical gas stove, heat is dissipated through the bottom only. This is addressed by the heat trap 40 in the coffee brewing pot 100 of the present invention.

When the coffee brewing pot 100 of the present invention is placed over a flame from a gas stove, the flame heats the bottom plate 11. Additionally, heat that rises from the flame and along the annular sidewall 12 is trapped within the heat trap 40. As the heat is trapped within the heat trap 40, the temperature of the annular sidewall 12 increases substantially so that the coffee within the open cavity 13 is heated from the bottom plate 11 and the sidewall 12. This mimics the pot being heated by placing it within hot sand where heat is dissipated from the bottom and the sidewall. Although, the coffee brewing pot 100 of the present invention can be produced without the heat trap 40, the preferred embodiment includes the heat trap 40 so as to mimic the type of heat dissipation that occurs when the pot is placed within hot sand as was done traditionally. Additionally, the heat trapped in the heat trap 40 also provides a heat source to brew the coffee in the annular cavity 34 of the overflow trap 30.

It is understood that the described embodiments of the present invention are illustrative only, and that modifications thereof may occur to those skilled in the art. Accordingly, this invention is not to be regarded as limited to the embodiments disclosed, but to be limited only as defined by the appended claims herein.

What is claimed is:

1. A coffee brewing pot comprising:
a coffee holder having a sidewall that defines an open cavity into which coffee and other ingredients are placed;
an overflow trap attached to said sidewall of said coffee holder; and
a handle.

2. A coffee brewing pot according to claim 1 further comprising a heat trap attached underneath said overflow trap.

3. A coffee brewing pot according to claim 1 wherein said coffee holder has a first pouring lip and said overflow trap has a second pouring lip whereas said overflow trap is attached to said coffee holder such that said first pouring lip is aligned with said second pouring lip.

4. A coffee brewing pot according to claim 1 wherein said coffee holder has a narrowing neck.

5. A coffee brewing pot according to claim 1 wherein said handle has an insulating cover.

6. A coffee brewing pot according to claim 5 wherein said handle is attached to said overflow trap in an upwardly angled direction such that a second end of said handle is at a higher level than a first end of said handle.
